(19) United States
(12) Patent Application Publication
(10) Pub. No.: US 2015/0360513 A1
(43) Pub. Date: Dec. 17, 2015

(54) WATERTIGHT DEVICE FOR DRIVE SHAFT FOR VEHICLE

(71) Applicants: Hyundai Motor Company, Seoul (KR); Kia Motors Corporation, Seoul (KR)

(72) Inventors: Hyo Seok KIM, Gwangmyeong-si (KR); Min Kyu KIM, Hwaseong-si (KR)

(73) Assignees: Hyundai Motor Company, Seoul (KR); Kia Motors Corporation, Seoul (KR)

(21) Appl. No.: 14/675,093

(22) Filed: Mar. 31, 2015

(30) Foreign Application Priority Data
Jun. 12, 2014 (KR) 10-2014-0071237

(51) Int. Cl. B60B 35/16

(52) U.S. Cl. CPC B60B 35/16; B60B 2900/511; B60Y 2200/10

(57) ABSTRACT

A watertight device for a drive shaft for a vehicle may include a middle shaft, an inner shaft which is formed integrally with an outer end portion of the middle shaft and has a first gear serration portion formed on an outer diameter portion of the inner shaft, and an outer wheel of the drive shaft which has a second gear serration portion formed on an inner diameter portion thereof, in which a sealer seating groove may be formed in a neck portion in a rear of the first gear serration portion of the inner shaft, a sealer may be press-fitted and mounted into the sealer seating groove, and thereafter, an outer diameter of the sealer may be compressed by an inner diameter portion at an inlet side of the second gear serration portion in an inner diameter section of the outer wheel of the drive shaft.

### CROSS-REFERENCE TO RELATED APPLICATION

The present application claims priority to Korean Patent Application No. 10-2014-0071237 filed Jun. 12, 2014 the entire contents of which is incorporated herein for all purposes by this reference.

### BACKGROUND OF THE INVENTION

1. Field of the Invention

The present disclosure relates to a watertight device for a drive shaft for a vehicle. More particularly, it relates to a watertight device for a drive shaft for a vehicle, which improves a watertight structure for the drive shaft for the vehicle, thereby preventing corrosion or the like of gear serration portions that connect an outer wheel of the drive shaft and an inner shaft.

2. Description of Related Art

In general, a drive shaft is a medium that finally transmits driving power generated from an engine/ a transmission to a road surface through wheels, and serves to absorb rotational displacement and various types of displacements of a vehicle which occur when the vehicle travels while transmitting power between the transmission and the wheels without incurring a difference in velocity.

In particular, in a high-performance FF vehicle (particularly, an SUV), a constant-length type drive shaft is mainly applied in consideration of various driving performance.

The constant-length type drive shaft has three components, that is, a left drive shaft, a right drive shaft, and a middle shaft that is connected to the left and right drive shafts so as to be able to transmit power to the left and right drive shafts.

In this case, the middle shaft and the respective drive shafts are fastened to be fitted with each other using gear serration portions.

The attached FIG. 1 illustrates a fastening structure in the related art between the middle shaft and the drive shafts.

As illustrated in FIG. 1, an inner shaft 12 formed integrally with an outer end portion of a middle shaft 10 and an outer wheel 22 formed at an inner end portion of a drive shaft 20 are connected to each other using gear serration portions so as to be able to transmit power.

In this case, first and second gear serration portions 14 and 24, which are coupled to each other, are formed on an outer diameter portion inside the inner shaft 12 and an inner diameter portion of the outer wheel 22 of the drive shaft 20, respectively.

Therefore, the outer diameter portion inside the inner shaft 12 is supported by a bearing 36, and the outer diameter portion outside the inner shaft 12 is inserted into and fastened into the inner diameter portion of the outer wheel 22 of the drive shaft 20 by means of the first and second gear serration portions 14 and 24 so as to be able to transmit power.

However, the aforementioned fastening structure in the related art between the inner shaft of the middle shaft and the drive shaft has the following problems.

First, a high-performance vehicle, particularly, an SUV vehicle frequently travels on an unpaved road, also called off-roading, and as a result, there is a problem in that water, salt water, soil, dust, and the like flow to the gear serration portions between the inner shaft and the outer wheel of the drive shaft such that corrosion and rust are severely produced on the serration portions, and there is a problem in that large amounts of time and costs are required to replace the drive shaft because of adhesion of an excessive amount of rust.

Second, when power is repeatedly transmitted through the gear serration portion in a case in which rust is produced on the gear serration portion, abrasion of the gear serration portion is further accelerated, and as a result, the vehicle may not travel.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a watertight device for a drive shaft for a vehicle, in which a watertight member is mounted between an inner shaft and an outer wheel of a drive shaft, such that water, salt water, soil, dust, and the like may be basically prevented from flowing to a gear serration portion, thereby preventing corrosion or rust from being produced on the gear serration portion, and preventing the gear serration portion from being abraded.

According to various aspects of the present invention, a watertight device for a drive shaft for a vehicle may include a middle shaft, an inner shaft which is formed integrally with an outer end portion of the middle shaft and has a first gear serration portion formed on an outer diameter portion of the inner shaft, and an outer wheel of the drive shaft which has a second gear serration portion formed on an inner diameter portion thereof, in which a sealer seating groove may be formed in a neck portion in a rear of the first gear serration portion of the inner shaft, a sealer may be press-fitted and mounted into the sealer seating groove, and thereafter, an outer diameter of the sealer may be compressed by an inner diameter portion at an inlet side of the second gear serration portion in an inner diameter section of the outer wheel of the drive shaft.

A chamfer, which prevents the sealer from being moved away from the sealer seating groove, may be formed on the inner diameter portion at the inlet side of the second gear serration portion of the outer wheel, and a rectilinear groove for compressing the outer diameter of the sealer may be formed in an immediate rear of the chamfer.

The sealer may have a ring type structure made of a single compressible soft material, and may have the outer diameter that is greater than an inner diameter at the inlet side of the second gear serration portion of the outer wheel.

The middle shaft may be connected to the drive shaft and configured to receive power generated by an engine.

According to various aspects of the present invention, a watertight device for a drive shaft for a vehicle may include a middle shaft, an inner shaft which is formed integrally with an outer end portion of the middle shaft and has a first gear serration portion formed on an outer diameter portion of the inner shaft, and an outer wheel of a drive shaft which has a second gear serration portion formed on an inner diameter portion thereof, in which a fixed type sealer may be press-fitted and mounted into a neck portion in a rear of the first gear serration portion of the inner shaft, and thereafter, an outer diameter of the fixed type sealer may be compressed by an inner diameter portion at an inlet side of the second gear serration portion in an inner diameter section of the outer wheel of the drive shaft.

The fixed type sealer may include a pipe ring which is made of a hard material and is press-fitted into the neck portion in the rear of the first gear serration portion of the inner shaft, and a watertight ring which is made of a soft material and is compressed by the inner diameter portion at the inlet side of the second gear serration portion of the outer wheel.

A chamfer, which prevents the fixed type sealer from being moved away from the neck portion in the rear of the first gear serration portion, may be formed on the inner diameter portion at the inlet side of the second gear serration portion of the outer wheel, and a rectilinear groove for compressing the watertight ring of the fixed type sealer may be formed in an immediate rear of the chamfer.

Through the aforementioned technical solutions, the present invention provides the effects below.

First, a watertight member such as the sealer is mounted between the inner shaft and the outer wheel of the drive shaft so as not to be moved away from the inner shaft and the outer wheel of the drive shaft, thereby basically preventing water, salt water, soil, dust, and the like from flowing to the gear serration portion.

Second, watertightness at the gear serration portion is achieved, thereby preventing corrosion or rust from being produced on the gear serration portion, and preventing the gear serration portion from being abraded.

Third, the sealer seating groove on which the sealer is seated is formed at the inner shaft side, and the chamfer and the rectilinear groove are formed at the outer wheel side of the drive shaft, thereby preventing the sealer from being moved away, and smoothly compressing the sealer.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating a fastening structure of a drive shaft for a vehicle in the related art.

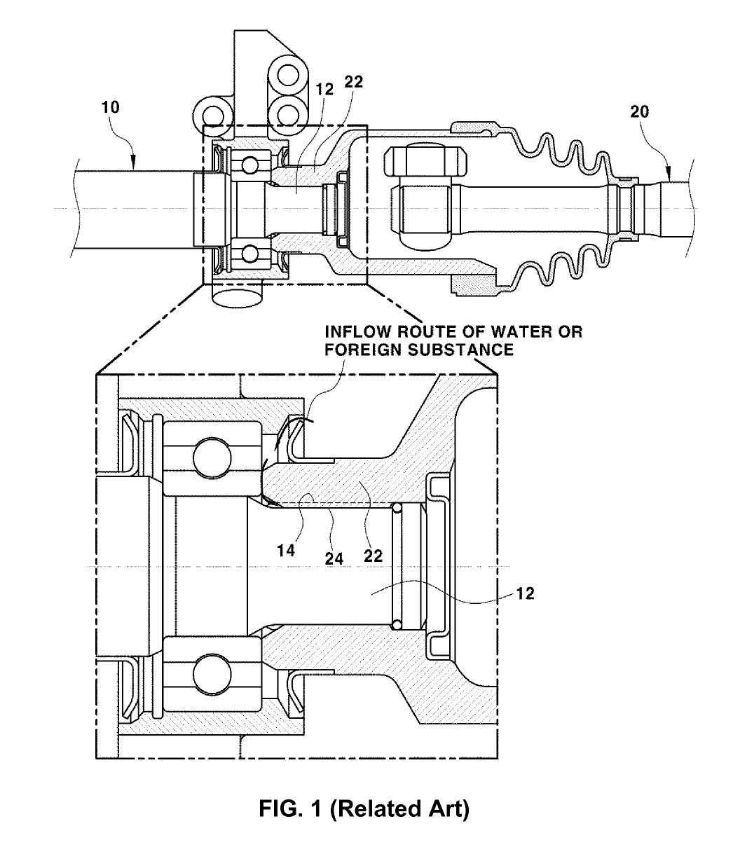

FIG. 2A and FIG. 2B are cross-sectional views illustrating an exemplary watertight device for a drive shaft for a vehicle according to the present invention.

FIG. 3A and FIG. 3B are cross-sectional views illustrating an exemplary watertight device for a drive shaft for a vehicle according to the present invention.

FIG. 4 is a perspective view illustrating a fixed type sealer structure that is applied to the exemplary watertight device for the drive shaft for the vehicle illustrated in FIG. 3A and FIG. 3B according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The subject matter of the present invention is that among components that constitute a constant-length type drive shaft of a vehicle, a left or right drive shaft and an inner shaft of a middle shaft, which is connected to left and right drive shafts so as to transmit power to the left and right drive shafts, may be connected to each other in a watertight manner.

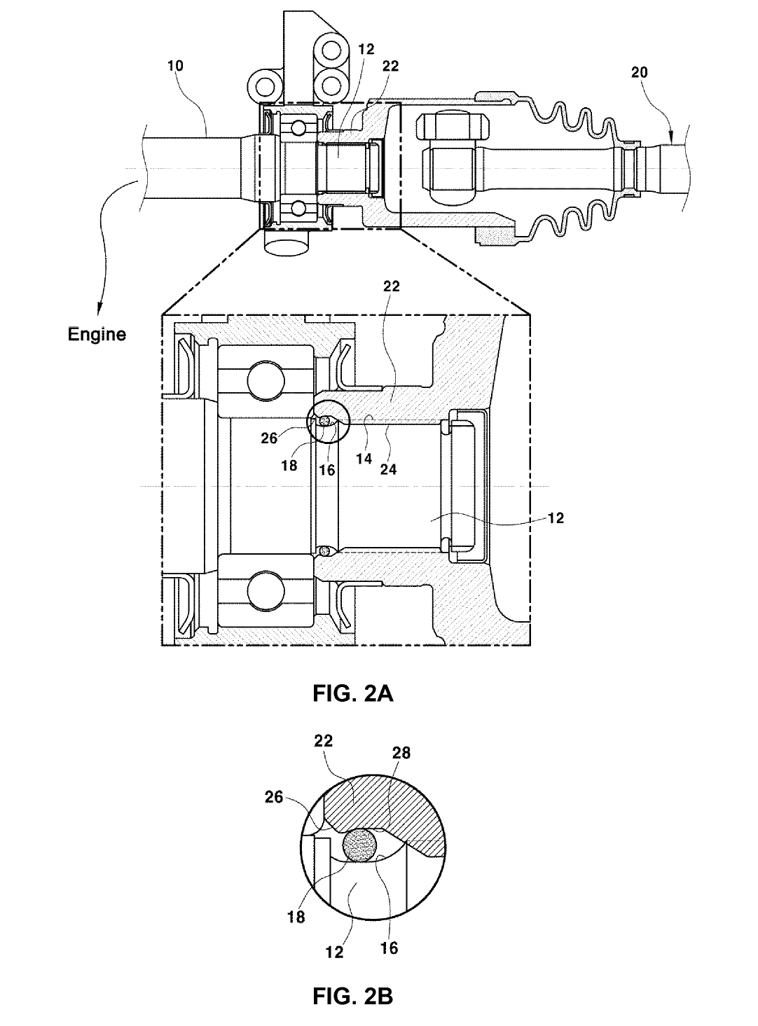

FIG. 2A and FIG. 2B are cross-sectional views illustrating a watertight device for a drive shaft for a vehicle according to various embodiments of the present invention.

In FIG. 2A and FIG. 2B, reference numeral 10 indicates a middle shaft that constitutes a constant-length type drive shaft, and reference numeral 20 indicates a left or right drive shaft which is connected with the middle shaft 10 so as to transmit power to the middle shaft 10.

An inner shaft 12 having a diameter smaller than that of the middle shaft 10 is formed integrally with an outer end portion of the middle shaft 10, and an outer wheel 22, which is coupled to the inner shaft 12, is formed integrally with an inner end portion of the drive shaft 20.

In this case, first and second gear serration portions 14 and 24, which are coupled to each other, are formed on an outer diameter portion inside the inner shaft 12 and an inner diameter portion of the outer wheel 22 of the drive shaft 20, respectively.

Therefore, the first gear serration portion 14 formed on the outer diameter portion of the inner shaft 12 is inserted into and fastened to the second gear serration portion 24 formed on the inner diameter portion of the outer wheel 22 of the drive shaft 20 so as to transmit power, such that driving power generated from an engine/a transmission is transmitted to a driving wheel.

According to various embodiments of the present invention, a sealer seating groove 16 is formed in a neck portion in the rear of the first gear serration portion 14 of the inner shaft 12, a sealer 18 is press-fitted and mounted into the sealer seating groove 16, and thereafter, an outer diameter of the sealer 18 is compressed by an inner diameter portion at an inlet side of the second gear serration 24 in an inner diameter section of the outer wheel 22 of the drive shaft 20.

The sealer 18 may be made to have a ring type structure using a single compressible soft material (for example, a soft polymer material such as rubber, silicone, or the like), and in order to assure a compression amount of the sealer 18 for maximizing a watertight effect, a sealer having an outer diameter greater than an inner diameter at the inlet side of the second gear serration portion 24 of the outer wheel 22 is adopted.

In particular, according to various embodiments of the present invention, a chamfer 26, which prevents the sealer 18 from being pushed and moved away from the sealer seating groove 16 when the outer wheel 22 of the drive shaft 20 is coupled to the inner shaft 12, is formed on the inner diameter portion at the inlet side of the second gear serration portion 24 of the outer wheel 22, and a rectilinear groove 28 for compressing the outer diameter of the sealer 18 is formed in the immediate rear of the chamfer 26.

Therefore, when the sealer 18 is press-fitted and mounted into the sealer seating groove 16 formed in the neck portion in the rear of the first gear serration portion 14 of the inner shaft 12, and thereafter, the outer wheel 22 of the drive shaft 20 is coupled to the inner shaft 12, the chamfer 26, which is formed at an inlet side of the inner diameter portion of the outer wheel 22, that is, the inlet side of the second gear serration portion 24, climbs over the outer diameter of the sealer 18, and at the same time, the outer diameter of the sealer 18 is connected with a section of the rectilinear groove 28 that is formed in the immediate rear of the chamfer 26.

In more detail, when the first gear serration portion 14 formed on the outer diameter portion of the inner shaft 12 and the second gear serration portion 24 formed on the inner diameter portion of the outer wheel 22 are coupled to each other in a state in which the sealer 18 is press-fitted and mounted into the sealer seating groove 16 of the inner shaft 12, the chamfer 26, which is formed at the inlet side of the second gear serration portion 24 of the outer wheel 22, climbs over the outer diameter of the sealer 18, such that the sealer 18 is maintained in place so as not to be moved away from the sealer seating groove 16.

Consecutively, after the chamfer 26 climbs over the outer diameter of the sealer 18, the outer diameter of the sealer 18 is positioned in a section of the rectilinear groove 28 that is formed in the immediate rear of the chamfer 26, and in this case, the outer diameter of the sealer 18 is greater than the inner diameter at the inlet side of the second gear serration portion 24 of the outer wheel 22, and as a result, the sealer 18 is compressed and fixed in a watertight manner between the sealer seating groove 16 of the inner shaft 12 and the rectilinear groove 28 of the outer wheel 22.

As such, according to various embodiments of the present invention, a watertight member such as the sealer 18 is mounted between the inner shaft 12 and the outer wheel 22 of the drive shaft 20 so as not to be moved away from the inner shaft 12 and the outer wheel 22 of the drive shaft 20, such that foreign substances such as water, salt water, soil, or dust may be basically prevented from flowing to the first and second gear serration portions 14 and 24, thereby easily preventing corrosion, rust, or abrasion of the first and second gear serration portions 14 and 24.

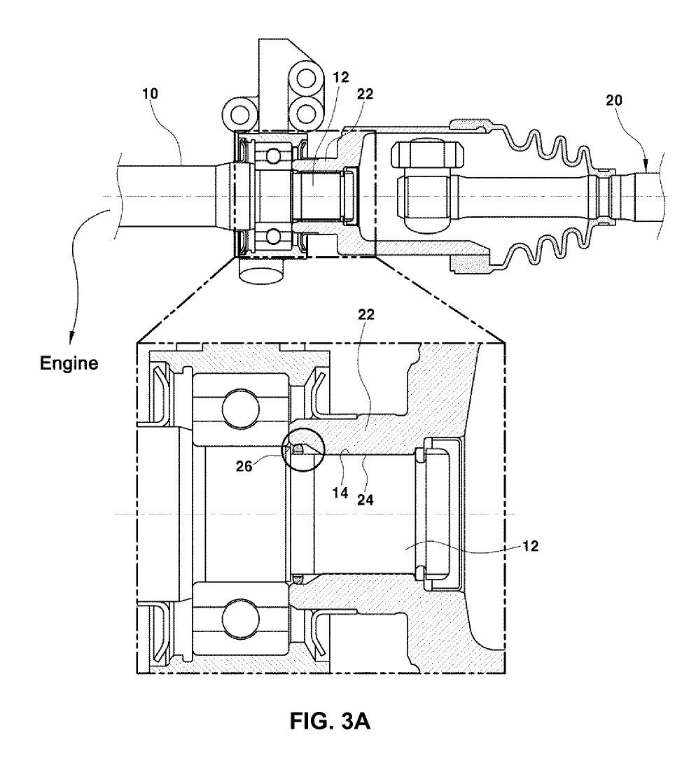

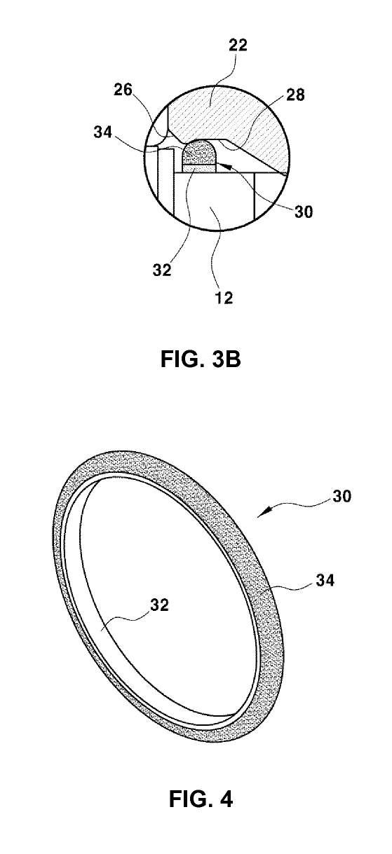

FIG. 3A and FIG. 3B are cross-sectional views illustrating a watertight device for a drive shaft for a vehicle according to various embodiments of the present invention, and FIG. 4 is a perspective view illustrating a fixed type sealer structure that is applied to the various embodiments of the present invention illustrated in FIG. 3A and FIG. 3B.

The subject matter of the various embodiments of the present invention illustrated in FIG. 3A and FIG. 3B reduce the number of assembly processes and prevent a clearance of a sealer while maintaining watertight performance as it is in comparison with previously described embodiments.

That is, the various embodiments of the present invention are characterized in that a process of machining the sealer seating groove in the inner shaft, which is performed in the previously described embodiments, is omitted, and a fixed type sealer made of different types of materials is directly press-fitted and mounted into a neck portion in the rear of the first gear serration 14 of the inner shaft 12 in order to prevent a clearance of a sealer from being formed in the sealer seating groove.

Referring to FIG. 4, a fixed type sealer 30 includes a pipe ring 32 which may be made of a hard material (for example, a metallic material such as steel, or aluminum, plastic, or the like but not limited thereto), and is directly press-fitted into the outer diameter of the neck portion in the rear of the first gear serration portion 14 of the inner shaft 12, and a watertight ring 34 which may be made of a soft material (for example, rubber, silicone, or the like, but not limited thereto), and is compressed by the inner diameter portion at the inlet side of the second gear serration portion 24 of the outer wheel 22.

Like the previously described embodiments, even in the various embodiments of the present invention illustrated in FIG. 3A and FIG. 3B, the chamfer 26, which prevents the fixed type sealer 30 from being moved away from the neck portion in the rear of the first gear serration portion 14, is formed on the inner diameter portion at the inlet side of the second gear serration portion 24 of the outer wheel 22, and the rectilinear groove 28 for compressing the watertight ring 34 of the fixed type sealer 30 is formed in the immediate rear of the chamfer 26.

Therefore, when the pipe ring 32 of the fixed type sealer 30 is directly press-fitted and mounted into the outer diameter of the neck portion in the rear of the first gear serration portion 14 of the inner shaft 12, and thereafter, the outer wheel 22 of the drive shaft 20 is coupled to the inner shaft 12, the chamfer 26, which is formed at an inlet side of the inner diameter portion of the outer wheel 22, that is, the inlet side of the second gear serration portion 24, climbs over the outer diameter of the watertight ring 34 of the fixed type sealer 30, and at the same time, the outer diameter of the watertight ring 34 is connected with a section of the rectilinear groove 28 that is formed in the immediate rear of the chamfer 26.

In more detail, when the first gear serration portion 14 formed on the outer diameter portion of the inner shaft 12 and the second gear serration portion 24 formed on the inner diameter portion of the outer wheel 22 are coupled to each other in a state in which the inner diameter of the pipe ring 32 of the fixed type sealer 30 is press-fitted and mounted into the outer diameter of the neck portion in the rear of the first gear serration portion 14 of the inner shaft 12, the chamfer 26 formed at the inlet side of the second gear serration portion 24 of the outer wheel 22 climbs over the outer diameter of the watertight ring 34 of the fixed type sealer 30, such that the fixed type sealer 30 is maintained in place without being moved.

Consecutively, after the chamfer 26 climbs over the outer diameter of the watertight ring 34 of the fixed type sealer 30, the outer diameter of the watertight ring 34 of the fixed type sealer 30 is positioned in a section of the rectilinear groove 28 that is formed in the immediate rear of the chamfer 26, and in this case, the outer diameter of the watertight ring 34 is greater than the inner diameter at the inlet side of the second gear serration portion 24 of the outer wheel 22, and as a result, the fixed type sealer 30 is compressed and fixed in a watertight manner between the outer diameter portion of the inner shaft 12 and the rectilinear groove 28 of the outer wheel 22.

As such, according to various embodiment of the present invention, a watertight member such as the fixed type sealer 30 is mounted between the inner shaft 12 and the outer wheel 22 of the drive shaft 20 so as not to be moved away from the inner shaft 12 and the outer wheel 22 of the drive shaft 20, such that foreign substances such as water, salt water, soil, or dust may be basically prevented from flowing to the first and second gear serration portions 14 and 24, and since it is not necessary to machine a separate sealer seating groove in the inner shaft unlike the previously described embodiments, the number of assembly processes may be reduced, and assembly workability may be improved in comparison with the previously described embodiments.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A watertight device for a drive shaft for a vehicle, comprising:
a middle shaft;
an inner shaft which is formed integrally with an outer end portion of the middle shaft and has a first gear serration portion formed on an outer diameter portion of the inner shaft; and
an outer wheel of the drive shaft which has a second gear serration portion formed on an inner diameter portion thereof,
wherein a sealer seating groove is formed in a neck portion in a rear of the first gear serration portion of the inner shaft, a sealer is press-fitted and mounted into the sealer seating groove, and thereafter, an outer diameter of the sealer is compressed by an inner diameter portion at an inlet side of the second gear serration portion in an inner diameter section of the outer wheel of the drive shaft.

2. The watertight device of claim 1, wherein a chamfer, which prevents the sealer from being moved away from the sealer seating groove, is formed on the inner diameter portion at the inlet side of the second gear serration portion of the outer wheel, and a rectilinear groove for compressing the outer diameter of the sealer is formed in an immediate rear of the chamfer.

3. The watertight device of claim 1, wherein the sealer has a ring type structure made of a single compressible soft material, and has the outer diameter that is greater than an inner diameter at the inlet side of the second gear serration portion of the outer wheel.

4. The watertight device of claim 1, wherein the middle shaft is connected to the drive shaft and configured to receive power generated by an engine.

5. A watertight device for a drive shaft for a vehicle, comprising:
a middle shaft;
an inner shaft which is formed integrally with an outer end portion of the middle shaft and has a first gear serration portion formed on an outer diameter portion of the inner shaft; and
an outer wheel of a drive shaft which has a second gear serration portion formed on an inner diameter portion thereof,
wherein a fixed type sealer is press-fitted and mounted into a neck portion in a rear of the first gear serration portion of the inner shaft, and thereafter, an outer diameter of the fixed type sealer is compressed by an inner diameter portion at an inlet side of the second gear serration portion in an inner diameter section of the outer wheel of the drive shaft.

6. The watertight device of claim 5, wherein the fixed type sealer includes:
a pipe ring which is made of a hard material and is press-fitted into the neck portion in the rear of the first gear serration portion of the inner shaft; and
a watertight ring which is made of a soft material and is compressed by the inner diameter portion at the inlet side of the second gear serration portion of the outer wheel.

7. The watertight device of claim 5, wherein a chamfer, which prevents the fixed type sealer from being moved away from the neck portion in the rear of the first gear serration portion, is formed on the inner diameter portion at the inlet side of the second gear serration portion of the outer wheel, and a rectilinear groove for compressing the watertight ring of the fixed type sealer is formed in an immediate rear of the chamfer.

8. The watertight device of claim 5, wherein the middle shaft is connected to the drive shaft and configured to receive power generated by an engine.
